(19) United States
(12) Patent Application Publication
(10) Pub. No.: US 2009/0058597 A1
(43) Pub. Date: Mar. 5, 2009

(54) VEHICLE COMMUNICATION SYSTEM

(75) Inventors: Toshimasa SHIBAGAKI, Aichi (JP); Masaki KAWASHIMA, Aichi (JP)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: KABUSHIKI KAISHA TOKAI RIKA DENKI SEISAKUSHO, Aichi (JP)

(21) Appl. No.: 12/204,476

(22) Filed: Sep. 4, 2008

(30) Foreign Application Priority Data
Sep. 4, 2007 (JP) 2007-229233

(51) Int. Cl. B60R 25/00

(52) U.S. Cl. 340/5.72

(57) ABSTRACT

A vehicle security system for improving convenience without lowering the security level. The vehicle communication system includes a plurality of portable devices and a communication controller, which communicates with the portable devices and controls a vehicle. The communication controller includes a first transmitter circuit, which transmits a first wireless signal within an area near the vehicle, a second transmitter circuit, which transmits a second wireless signal within an area in the passenger compartment of the vehicle, and a communication control unit, which controls at least the closing of a door lock. When a door lever is operated in a state in which the door lock is closed, the communication control unit closes the door lock when one of the portable devices is located near the vehicle and keeps the door lock closed when none of the portable devices is located near the vehicle.

### CROSS-REFERENCE TO RELATED APPLICATIONS

This application is based upon and claims the benefit of priority from the prior Japanese Patent Application No. 2007-229233, filed on Sep. 4, 2007, the entire contents of which are incorporated herein by reference.

### BACKGROUND OF THE INVENTION

The present invention relates to a vehicle communication system.

Nowadays, in addition to improving basic performance and safety, convenience must also be improved for automobiles. Vehicle communication systems are used to improve convenience. In a vehicle communication system, wireless communication is automatically performed between a portable device, which is carried by a user, and an in-vehicle device (vehicle controller). When wireless communication is established between the portable device and in-vehicle device, for example, the vehicles doors may be automatically locked or unlocked. Also, the starting of the engine may be enabled. Japanese Laid-Open Patent Publication No. 2001-114073 describes such a vehicle communication system.

More specifically, an in-vehicle device intermittently transmits a wireless signal (request signal) to an area near or in a vehicle. When a request signal is transmitted to an area near the vehicle, the request signal is transmitted within a predetermined range near the vehicle (vehicle exterior range). When a request signal is transmitted to an area in the vehicle, the request signal is transmitted within a predetermined range in the passenger compartment of the vehicle (passenger compartment range). Thus, when a user (e.g., driver), who is carrying a portable device provided with a communication function, enters the vehicle exterior range or passenger compartment range, the portable device receives the request signal and, in response, returns an identification code signal, which includes an identification code uniquely set for the portable device. The in-vehicle device receives the identification code signal and verifies the identification code included in the received signal with an identification code uniquely set for the in-vehicle device. If the two identification codes are the same, the vehicle controller determines that communication has been established with the portable device. In this state, if the identification code signal is received from the portable device in response to a request signal transmitted to the vehicle exterior range, the vehicle controller enables unlocking of the vehicle doors. If the identification code signal is received from the portable device in response to a request signal transmitted within the passenger compartment range, the vehicle controller enables starting of the engine. That is, communication is automatically performed between the in-vehicle device and the portable device, and door unlocking control or engine starting control is executed under the condition that communication has been established. This eliminates burdensome operations that require a mechanical key to unlock the doors or start the engine and improves the operability of the vehicle. Further, since the locking and unlocking of the doors and the starting of the engine are controlled based on electronic verification, the security level is also improved.

In the vehicle communication system described in the above publication, to prevent the portable device from being left behind in the passenger compartment, when an operation for locking the doors is performed in a state in which the portable device is located in the passenger compartment, a misplacement warning is issued and the locking of the doors is disabled.

Thus, when a plurality of portable devices are registered for use in the same vehicle, if any one of the portable device is left in the passenger compartment, the doors of the vehicle cannot be locked. For example, when the driver and another vehicle occupant are each holding a portable device, if the driver, who is carrying one of the portable devices, gets out of the vehicle together with the other vehicle occupant, who leaves the other portable device in the passenger compartment, the driver cannot lock the doors even when performing the door locking operations. In such a case, all of the portable devices must be taken out from the passenger compartment. Thus, improvements must be made from the viewpoint of convenience.

### SUMMARY OF THE INVENTION

The present invention provides a vehicle communication system that improves convenience while without lowering the security level.

One aspect of the present invention is a vehicle communication system for use with a vehicle having a passenger compartment, a door lock, and a switch which opens and closes the door lock. The vehicle communication system includes a plurality of portable devices and a communication controller which communicates with the plurality of portable devices and controls the vehicle. The communication controller includes a first transmitter circuit, a second transmitter circuit, and a control unit. The first transmitter circuit transmits a first wireless signal within an area near the vehicle. The second transmitter circuit transmits a second wireless signal within an area in the passenger compartment of the vehicle. The control unit controls at least the closing of the door lock. The control unit determines that a portable device is located near the vehicle when receiving a response signal from the portable device in response to the first wireless signal and determines that a portable device is located in the passenger compartment of the vehicle when receiving a response signal from the portable device in response to the second wireless signal. When the switch is operated in a state in which the door lock is open, the control unit closes the door lock when at least one of the plurality of portable devices is located near the vehicle and keeps the door lock open when none of the plurality of portable devices is located near the vehicle.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a diagram illustrating a vehicle communication system;

FIG. 2 is a diagram illustrating a communication range of the vehicle;

FIG. 3 is a diagram illustrating a communication range of the vehicle;

FIG. 4 is a flowchart illustrating the procedures for executing lock operation control; and

FIG. 5 is a flowchart illustrating the procedures for executing unlock operation control.

### DETAILED DESCRIPTION OF THE PREFERRED EMBODIMENTS

In the drawings, like numerals are used for like elements throughout.

A first embodiment of a vehicle communication system 1 according to the present invention will now be discussed with reference to the drawings.

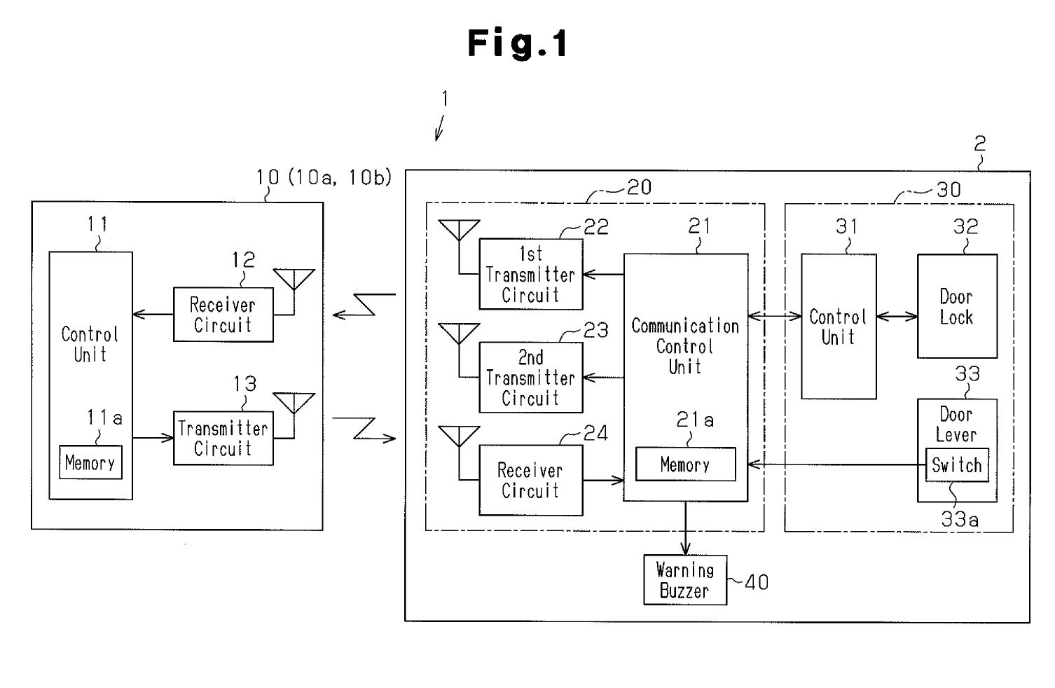

Referring to FIG. 1, the vehicle communication system 1 includes a plurality of (in this embodiment, two) portable devices 10 (10a and 10b) that may be carried by a driver of a vehicle 2, an in-vehicle device 20 functioning as a communication controller arranged in the vehicle 2, a door 30, and a warning buzzer 40 for issuing warnings. For example, one of the two portable devices 10, namely, the portable device 10a, is carried by the driver and the other portable device 10b is carried by another vehicle occupant. Communication is automatically performed between the in-vehicle device 20 and the portable devices 10 (10a and 10b). The door 30 is locked and unlocked in a state in which communication is established between the in-vehicle device 20 and the portable devices 10 (10a and 10b).

### <Structure of the Portable Device 10>

Each portable device 10 implements a wireless communication function and is communicable with the in-vehicle device 20. More particularly, the portable device 10 includes a control unit 11, a receiver circuit 12, and a transmitter circuit 13. The control unit 11 is a computer unit including a CPU, ROM, and RAM. The receiver circuit 12 is electrically connected to the control unit 11.

When receiving a wireless signal (request signal) transmitted from the in-vehicle device 20, the receiver circuit 12 demodulates the request signal to a pulse signal and provides the demodulated signal to the control unit 11.

The control unit 11 includes a non-volatile memory 11a, which records a unique identification (ID) code. When receiving the demodulated signal from the receiver circuit 12, the control unit 11 provides the transmitter circuit 13 with an ID code signal including the ID code recorded in the memory 11a.

When receiving the ID code signal from the control unit 11, the transmitter circuit 13 modulates the ID code signal to a wireless signal having a predetermined frequency and transmits the wireless signal.

### <Structure of the In-Vehicle Device 20>

The in-vehicle device 20 includes a communication control unit 21 serving as a control means, a first transmitter circuit 22 functioning as a first transmission means, a second transmitter circuit 23 functioning as a second transmission means, and a receiver circuit 24. The communication control unit 21 is a computer unit including a CPU, ROM, and RAM. The first transmitter circuit 22, the second transmitter circuit 23, and the receiver circuit 24 are electrically connected to the communication control unit 21.

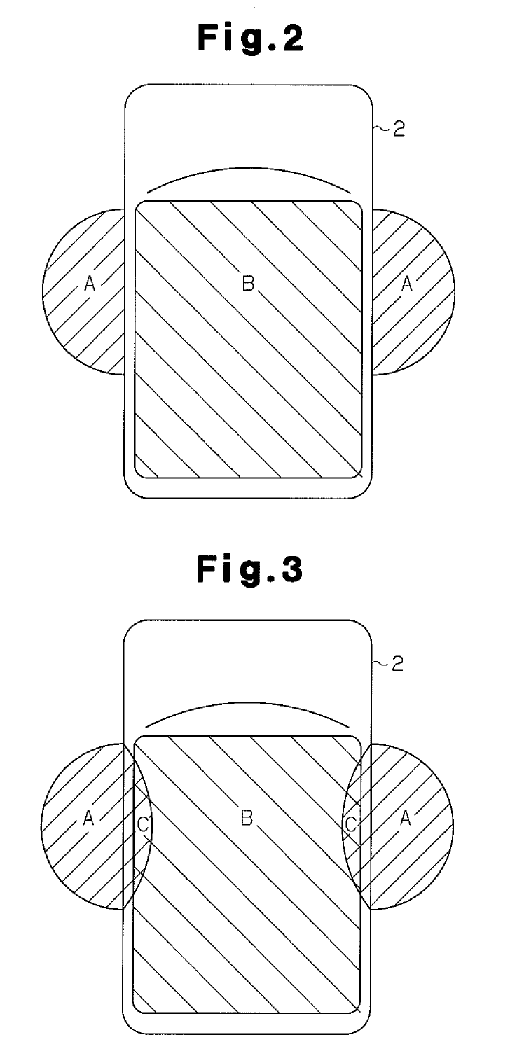

When receiving a request signal from the communication control unit 21, the first transmitter circuit 22 modulates the request signal to a wireless signal having a predetermined frequency and transmits the wireless signal within predetermined areas near the vehicle 2 (transmission ranges A shown in FIG. 2). When the second transmitter circuit 23 receives the request signal from the communication control unit 21, the second transmitter circuit 23 modulates the request signal to a wireless signal having a predetermined frequency and transmits the wireless signal within a predetermined area in the passenger compartment of the vehicle 2 (transmission range B shown in FIG. 2). The transmission ranges A are not overlapped with the transmission range B.

When receiving a wireless signal (ID code signal) transmitted from the portable device 10, the receiver circuit 24 demodulates the ID code signal to a pulse signal and provides the demodulated signal to the communication control unit 21.

The communication control unit 21 includes a non-volatile memory 21a. The memory 21a records a plurality of ID codes that are the same as the ID codes set for the portable devices 10a and 10b.

The communication control unit 21 intermittently sends request signals to the first transmitter circuit 22 and the second transmitter circuit 23 at different timings. In response to the wireless signal (request signal) transmitted from the first transmitter circuit 22 or the second transmitter circuit 23, the portable device 10 transmits a wireless signal (ID code signal). When receiving the wireless signal (ID code signal), the communication control unit 21 determines whether the portable device 10 is located near the vehicle 2 or in the passenger compartment of the vehicle 2 based on whether the ID code signal was transmitted from the portable device 10 in response to the request signal transmitted from the first transmitter circuit 22 or the second transmitter circuit 23. Then, the communication control unit 21 controls the locking and unlocking of the door 30 based on the determination. More specifically, the communication control unit 21 provides the door 30 with an unlocking signal when a switch 33a (operation means) of a door lever 33 (described later) is pushed in a state in which ID code verification is established near the vehicle 2. The communication control unit 21 provides the door 30 with a locking signal when the switch 33a of the door lever 33 is pushed in a state in which ID code verification is not established in the passenger compartment of the vehicle 2. The unlocking signal is a signal for unlocking the door 30, and the locking signal is a signal for locking the door 30.

### <Structure of the Door>

The door 30 includes a door lock 32, a control unit 31 for controlling the opening and closing of the door lock 32, and the door lever 33, which is arranged on the outer surface of the vehicle 2 and used to open and close the door 30. The door lever 33 includes the switch 33a, which is pushed when a locking or unlocking operation is performed on the door 30. The switch 33a of the door lever 33 is electrically connected to the communication control unit 21. When pushed, the switch 33a provides the communication control unit 21 with an operation signal.

The control unit 31 opens the door lock 32 when receiving an unlocking signal from the communication control unit 21. Further, the control unit 31 closes the door lock 32 when receiving a locking signal from the communication control unit 21. Then, the control unit 31 provides the communication control unit 21 with a lock state signal indicating whether the door lock 32 is open or closed.

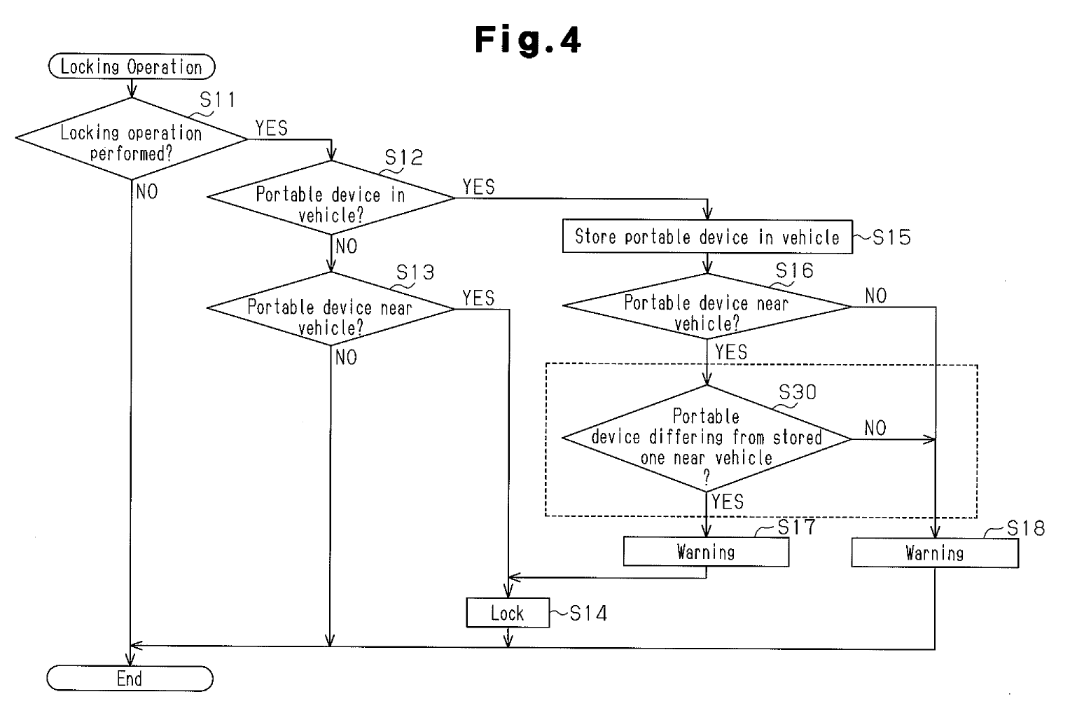

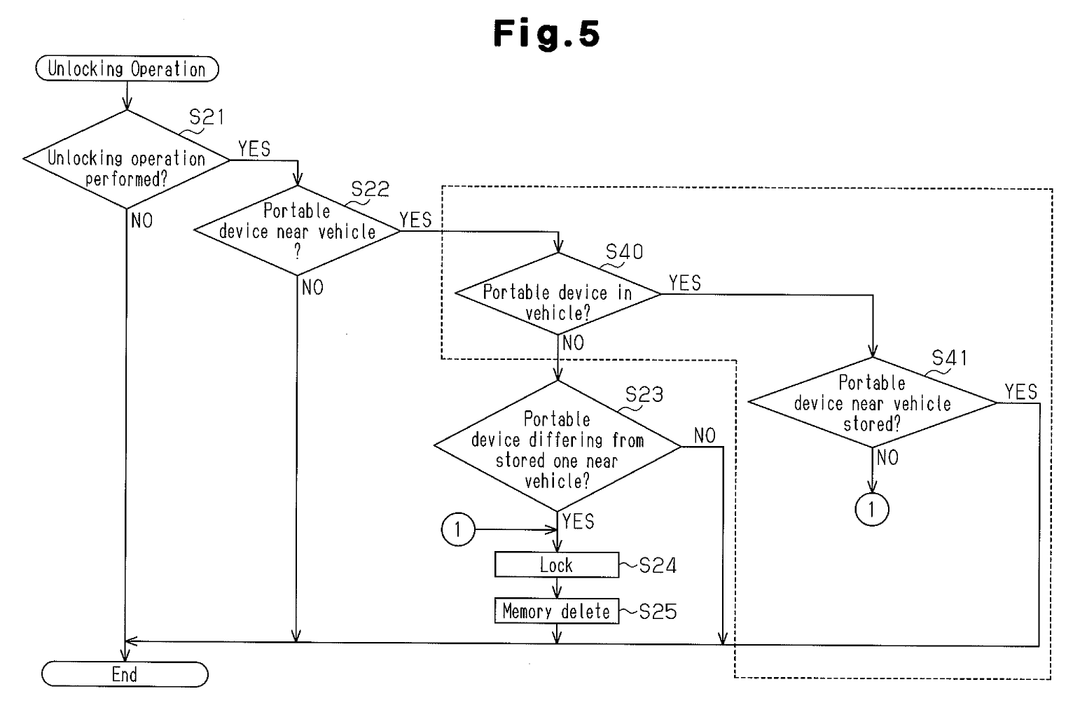

Locking and unlocking operations performed by the vehicle communication system 1 will now be discussed with reference to FIGS. 4 and 5. In this embodiment, the communication control unit 21 does not perform the processes shown in the boxes drawn by broken lines in FIGS. 4 and 5.

### <Locking Operation>

First, the processing performed by the communication control unit 21 in a state in which the door lock 32 of the vehicle 2 is open when the user (driver or vehicle occupant) gets out of the vehicle 2 and closes the door lock 32 will be discussed.

Referring to the flowchart of FIG. 4, the communication control unit 21 determines whether or not the driver or vehicle occupant has performed a locking or unlocking operation with the switch 33a of the door lever 33 (step S11). More specifically, the communication control unit 21 determines whether or not it has received an operation signal transmitted from the switch 33a of the door lever 33 based on a pushing operation performed by the driver or the occupant. When a locking or unlocking operation has not been performed, that is, when an operation signal has not been received (step S11: NO), the communication control unit 21 ends the processing.

If a locking or unlocking operation has been performed (step S11: YES), the communication control unit 21 determines whether or not any one of the portable devices 10a and 10b is located in the passenger compartment of the vehicle 2 in the transmission range B (step S12). When the portable devices 10a and 10b are not located in the passenger compartment of the vehicle 2 in the transmission range B (step S12: NO), the communication control unit 21 proceeds to step S13.

In step S13, the communication control unit 21 determines whether or not at least one of the portable devices 10a and 10b is located near the vehicle 2 in the transmission ranges A. If none of the portable devices 10a and 10b are located near the vehicle 2 in the transmission ranges A (step S10: NO), the communication control unit 21 ends the processing. If at least one of the portable devices 10a and 10b are located near the vehicle 2 in the transmission ranges A (step S10: YES), the communication control unit 21 provides the control unit 31 of the door 30 with a locking signal for closing the door lock 32 and locks the door 30 (step S14). Then, the communication control unit 21 ends the processing.

In step S12, if at least one of the portable devices 10a and 10b is located in the passenger compartment of the vehicle 2 in the transmission range B (step S12: YES), the communication control unit 21 proceeds to step S15. Here, it is assumed that vehicle occupant's portable device 10b is located in the passenger compartment. In this case, in step S15, the communication control unit 21 stores in the memory 21a the ID code of the portable device 10b located in the passenger compartment of the vehicle 2.

Then, the communication control unit 21 determines whether or not a portable device 10 is located near the vehicle 2 in the transmission ranges A (step S16). In this case, if a portable device 10 is located near the vehicle 2 in the transmission ranges A, that would be the portable device 10a. When the portable device 10a is located near the vehicle 2 in the transmission ranges A (step S16: YES), the communication control unit 21 closes the door lock 32 to lock the door 30. In detail, the communication control unit 21 generates a warning sound for misplacement notification of the portable device 10b (step S17). Then, the communication control unit 21 provides the control unit 31 of the door 30 with a locking signal for closing the door lock 32 (step S14). In this manner, even if the portable device 10b is located in the vehicle 2, the door 30 is locked as long as the portable device 10a is located outside the vehicle 2 in the transmission ranges A.

When the portable device 10a is not located near the vehicle 2 in the transmission ranges A (step S16: NO), the communication control unit 21 generates a warning sound for misplacement notification (step S18). The warnings generated in step S17 and S18 may be the same sound or different sounds. When different sounds are generated, the pitch, type, or interval of each sound may be changed.

### <Unlocking Operation>

The processing performed by the communication control unit 21 in a state in which the door lock 32 of the vehicle 2 is closed and the driver or vehicle occupant approaches the vehicle 2 and opens the door lock 32 will now be discussed.

Referring to the flowchart of FIG. 5, the communication control unit 21 determines whether or not the driver or vehicle occupant has performed a locking or unlocking operation with the switch 33a of the door lever 33 (step S21). In detail, the communication control unit 21 determines whether or not it has received an operation signal transmitted from the switch 33a of the door lever 33 based on a pushing operation performed by the driver or the occupant. When a locking or unlocking operation has not been performed, that is, when an operation signal has not been received (step S21: NO), the communication control unit 21 ends the processing.

If a locking or unlocking operation has been performed (step S21: YES), the communication control unit 21 determines whether or not any one of the portable devices 10a and 10b is located near the vehicle 2 in the transmission ranges A (step S22). When none of the portable devices 10a and 10b are located near the vehicle 2 in the transmission ranges A (step S22: NO), the communication control unit 21 ends the processing.

In step S22, if at least one of the portable devices 10a and 10b is located near the vehicle 2 in the transmission ranges A (step S22: YES), the communication control unit 21 determines whether a portable device 10 (i.e., portable device 10a) that differs from the portable device 10 (i.e., portable device 10b) of which the ID code was stored in the memory 21 during the above-mentioned locking operation is located near the vehicle 2 in the transmission ranges A (step S23). For example, the communication control unit 21 compares the ID code of the portable device 10a located near the vehicle 2 in the transmission ranges A with the ID code of the portable device 10b stored in the memory 21a to determine whether or not the portable device 10a is located near the vehicle 2 in the transmission ranges A. If the portable device 10a is not located in the transmission ranges A (step S23: NO), the communication control unit 21 ends the processing. Thus, even if a person breaks into the vehicle 2 and obtains the portable device 10b, which has been left in the passenger compartment, that person would not be able to open the door lock 32 with the portable device 10b.

In step S23, when the portable device 10a is located near the vehicle 2 in the transmission ranges A (step S23: YES), the communication control unit 21 provides the control unit 31 of the door 30 with an unlocking signal for opening the door lock 32 and unlocks the door 30 (step S24). Then, the communication control unit 21 deletes the ID code of the portable device 10b that was stored in the memory 21a during the above-mentioned locking operation and ends the processing.

The first embodiment of the vehicle communication system 1 has the advantages described below.

(1) When a locking operation is performed in a state in which the door lock 32 is open and the door 30 is unlocked, the door lock 32 can be closed as long as a portable device 10 is located near the vehicle 2 in the transmission ranges A. Thus, the door lock 32 can be closed even if a portable device 10 is located in the passenger compartment of the vehicle 2 in the transmission range B. In this state, the communication control unit 21 recognizes that one of the portable devices 10a and 10b is located outside the vehicle 2. This prevents the user from being locked out from the vehicle 2 when leaving both of the portable devices 10a and 10b in the vehicle 2. Accordingly, the user can enter the vehicle 2 when a portable device 10 is located near the vehicle 2 in the transmission ranges A. Thus, convenience is improved without lowering the security level.

(2) When a portable device 10 is left in the passenger compartment of the vehicle 2 in the transmission range B, a misplacement warning is generated. This notifies the driver and occupant of the vehicle 2 that a portable device 10 has been left in the passenger compartment of the vehicle 2. Further, the communication control unit 21 stores the ID code of the portable device 10 located in the passenger compartment of the vehicle 2 in the transmission range B. Accordingly, the in-vehicle device 20 recognizes the portable device 10 located in the passenger compartment of the vehicle 2 in the transmission range B.

(3) When an unlocking operation is performed in a state in which the door lock 32 is closed, the communication control unit 21 compares the ID code of each portable device 10 located near the vehicle 2 in the transmission ranges A with the ID code of each portable devices 10 stored during the previous locking operation (the portable device 10 that was located in the passenger compartment of the vehicle in the transmission range B during the locking operation) to determine whether or not to open the door lock 32. The portable device 10a, which differs from the portable device 10b of which the ID code was stored during the previous locking operation, must be located near the vehicle 2 in the transmission ranges A to open the door lock 32. Therefore, for example, even if the driver and occupant of the vehicle 2 leaves the portable device 10b in the passenger compartment and then a person breaks into the passenger compartment and obtains the portable device 10b, that person would not be able to open the door lock 32 with the portable device 10b. Thus, the same security level can be maintained. Furthermore, even if noise results in the communication control unit 21 erroneously determining that the portable device 10b is located near the vehicle 2 in the transmission ranges A when it is actually located in the passenger compartment of the vehicle 2 in the transmission range B, the portable device 10b cannot open the door lock 32 due to the ID code of the portable device 10b that was left in the passenger compartment of the vehicle 2 stored during the previous locking operation. Thus, the same security level can be maintained even during such an unexpected situation.

(4) After the ID code of the portable device 10b located in the passenger compartment of the vehicle 2 in the transmission range B is stored during a locking operation, the door lock 32 is closed with the other portable device 10a. When the next locking operation is performed, any one of the portable devices 10 may be left in the passenger compartment of the vehicle 2 in the transmission range B. For this reason, when the communication control unit 21 opens the door lock 32, the previously stored ID code is deleted. Thus, ID code information is not accumulated, and the storage of unnecessary information is avoided thereby minimizing the required storage capacity.

A second embodiment of a vehicle communication system 1 according to the present invention will now be discussed with reference to FIGS. 3 to 5. The second embodiment of the vehicle communication system 1 differs from the first embodiment in that the transmission ranges A and B of the wireless signals transmitted from the in-vehicle device 20 are partially overlapped and form overlapping transmission ranges C. Further, in the second embodiment, the communication control unit 21 performs the processes shown in the boxes drawn by broken lines in FIGS. 4 and 5. Differences from the first embodiment will mainly be described below. In the second embodiment, the vehicle communication system 1 has the same structure as the vehicle communication system 1 shown in FIG. 1.

More specifically, referring to FIG. 3, when receiving a request signal from the communication control unit 21, the first transmitter circuit 22 of the in-vehicle device 20 modulates the request signal to a wireless signal having a predetermined frequency and transmits the wireless signal within the transmission ranges A near the vehicle 2. When the second transmitter circuit 23 of the in-vehicle device 20 receives the request signal from the communication control unit 21, the second transmitter circuit 23 modulates the request signal to a wireless signal having a predetermined frequency and transmits the wireless signal within the transmission range B in the passenger compartment of the vehicle 2. The transmission ranges A near the vehicle 2 are partially overlapped with the transmission range B at overlapping transmission ranges C in the passenger compartment of the vehicle 2. Thus, when the portable device 10 is located in the overlapping transmission ranges C in the passenger compartment of the vehicle 2, the communication control unit 21 determines that the portable device 10 may be located near the vehicle 2 and in the passenger compartment of the vehicle 2.

The locking and unlocking operations performed by the second embodiment of the vehicle communication system 1 will now be described with reference to FIGS. 4 and 5.

### <Locking Operation>

First, the processing performed by the communication control unit 21 in a state in which the door lock 32 of the vehicle 2 is open when the user (driver or vehicle occupant) gets out of the vehicle 2 and closes the door lock 32 will be discussed.

As shown in the flowchart of FIG. 4, in step S16, when a portable device 10 is located near the vehicle 2 in the transmission ranges A (step S16: YES), the communication control unit 21 proceeds to step S30. Based on the ID code of the portable device 10b located in the transmission range B in the passenger compartment of the vehicle 2 that has been stored in the memory 21a in step S15 and the ID code of the portable device 10 located in the transmission ranges A near the vehicle 2, the communication control unit 21 determines whether or not a portable device 10 that differs from the portable device 10b (in this case, the portable device 10a) is located in the transmission ranges A near the vehicle 2 (step S30: YES). If the portable device 10a, which differs from the portable device 10b, is located in the transmission ranges A near the vehicle 2 (step S30: YES), the communication control unit 21 proceeds to step S17.

When a portable device 10 that differs from the portable device 10b is not located in the transmission ranges A near the vehicle 2 (step S30: NO), the communication control unit 21 proceeds to step S18.

### <Unlocking Operation>

The processing performed by the communication control unit 21 in a state in which the door lock 32 of the vehicle 2 is closed and the driver or vehicle occupant approaches the vehicle 2 and opens the door lock 32 will now be discussed.

As shown in the flowchart of FIG. 5, in step S22, when at least one of the portable devices 10a and 10b is located near the vehicle 2 in the transmission ranges A (step S22: YES), the communication control unit 21 determines whether or not a portable device 10 is located in the transmission range B in the passenger compartment of the vehicle 2 (step S40). If a portable device 10 is located in the transmission range B in the passenger compartment of the vehicle 2, that portable device 10 would be the portable device 10b that was stored in the memory 21a during the above-mentioned locking operation. When the portable device 10b is not located in the transmission range B in the passenger compartment of the vehicle 2 (step S40: NO), the communication control unit 21 proceeds to step S23.

When the portable device 10b is located in the transmission range B in the passenger compartment of the vehicle 2 (step S40: YES), the communication control unit 21 proceeds to step S41. In step S41, the communication control unit 21 determines whether or not the portable device 10 located in the transmission ranges A near the vehicle 2 is the portable device 10b that is located in the transmission range B in the passenger compartment of the vehicle 2, that is, the portable device 10b stored in the memory 21a (step S41). If the portable device 10 located in the transmission ranges A near the vehicle 2 is the portable device 10b (step S41: YES), the communication control unit 21 ends the processing.

In step S41, when the portable device 10 located in the transmission ranges A near the vehicle 2 is not the portable device 10b (step S41: NO), the communication control unit 21 proceeds to step S24.

In addition to advantages (1) to (4) of the first embodiment, the second embodiment of the vehicle communication system 1 has the following advantage.

(5) If a portable device 10 (e.g., the portable device 10b) is located in the transmission range B in the vehicle compartment of the vehicle 2 when the door lock 32 is closed, the door lock 32 opens only when a portable device 10 that differs from the portable device 10b (in this case, the portable device 10a) is located in the transmission ranges A near the vehicle 2. For example, if the portable device 10b is located in the overlapping transmission ranges C in the passenger compartment of the vehicle 2, the portable device 10b is detected as being located in the transmission ranges A near the vehicle 2 and in the transmission range B in the passenger compartment of the vehicle 2. In this case, only the portable device 10b that is actually located in the transmission range A near the vehicle 2 is stored in the memory 21a. Accordingly, even if the portable device 10b is erroneously determined as being located in the transmission ranges A near the vehicle 2, the door lock 32 does not open unless the other remaining portable device 10a is located in the transmission ranges A near the vehicle 2. This prevents the portable device 10b from being left in the vehicle 2. In this manner, in the second embodiment, when the transmission ranges A near the vehicle 2 overlap the transmission range B in the passenger compartment of the vehicle 2, the portable device 10b is prevented from being left in the vehicle 2. Thus, there is no need to accurately adjust the boundary between the transmission ranges A of the first transmitter circuit 22 and the transmission range B of the second transmitter circuit 23 for the in-vehicle device 20. This facilitates adjustments.

It should be apparent to those skilled in the art that the present invention may be embodied in many other specific forms without departing from the spirit or scope of the invention. Particularly, it should be understood that the present invention may be embodied in the following forms.

In the above embodiments, the locking and unlocking operations are detected when the switch 33a on the door lever 33 is pushed. However, such operations may be detected in a non-contact manner.

In the above embodiments, the locking and unlocking operations do not have to be performed with the door lever 33 and may be performed with another component that is installed in the vehicle 2.

In the above embodiments, as long as the memory 21a has sufficient storage capacity, the ID code of the portable device 10 stored in the memory 21a does not have to be deleted and can be continuously stored in the memory 21a when a portable device 10 located near the vehicle 2 opens the door lock 32. In other words, step S25 may be eliminated from the flowchart of FIG. 4.

In the above embodiments, a misplacement warning is issued when a portable device 10 is left in the passenger compartment of the vehicle during a locking operation. However, if it is important that a third person does not become aware of the portable device 10 located in the passenger compartment of the vehicle 2, the misplacement warning can be cancelled. In other words, steps S17 and S18 may be eliminated from the flowchart of FIG. 4.

In the above embodiments, when a portable device 10 is located in the passenger compartment of the vehicle 2 during a locking operation, the ID code of the portable device 10 that is located in the passenger compartment of the vehicle 2 is stored in the memory 21a of the communication control unit 21. However, to ensure sufficient storage capacity for storing the ID code of the portable device 10 or to simplify the specification, the portable device 10 located in the passenger compartment of the vehicle 2 and the portable device 10 located near the vehicle 2 do not have to be compared during an unlocking operation. Further, the ID code storage does not have to be performed during a locking operation. That is, step S15 may be eliminated from the flowchart of FIG. 4. For example, in the second embodiment, if a portable device 10 is not located in the vehicle 2 when closing the door lock 32 (step S40: NO), step S23 does not have to be performed. In this case, the communication control unit 21 determines that a portable device 10 is not located in the passenger compartment of the vehicle 2 during the locking operation, that is, a portable device 10 was not left in the vehicle 2, and performs only an unlocking process and skips subsequent step S25. However, if a portable device 10 is located in the passenger compartment of the vehicle 2 (step S40: YES), the communication control unit 21 proceeds to step S41 and then, depending on the determination of step S41, performs steps S24 and S25 (in this case, it is necessary that step S15 is not eliminated).

In the above embodiments, the transmission ranges A and B, which are formed by the transmission of wireless signals from the in-vehicle device 20 may be varied in accordance with the vehicle type or specification.

The present examples and embodiments are to be considered as illustrative and not restrictive, and the invention is not to be limited to the details given herein, but may be modified within the scope and equivalence of the appended claims.

What is claimed is:

1. A vehicle communication system for use with a vehicle having a passenger compartment, a door lock, and a switch which opens and closes the door lock, the vehicle communication system comprising:
a plurality of portable devices; and
a communication controller which communicates with the plurality of portable devices and controls the vehicle, the communication controller including:
a first transmitter circuit which transmits a first wireless signal within an area near the vehicle;
a second transmitter circuit which transmits a second wireless signal within an area in the passenger compartment of the vehicle; and
a control unit which controls at least the closing of the door lock, in which the control unit determines that a portable device is located near the vehicle when receiving a response signal from the portable device in response to the first wireless signal and determines that a portable device is located in the passenger compartment of the vehicle when receiving a response signal from the portable device in response to the second wireless signal;
wherein when the switch is operated in a state in which the door lock is open, the control unit closes the door lock when at least one of the plurality of portable devices is located near the vehicle and keeps the door lock open when none of the plurality of portable devices is located near the vehicle.

2. The vehicle communication system according to claim 1, wherein when the switch is operated in a state in which the door lock is open, the control unit closes the door lock when one of the plurality of portable devices is located near the vehicle even if another one of the portable devices is located in the passenger compartment of the vehicle.

3. The vehicle communication system according to claim 1, wherein:
the plurality of portable devices each include an identification code; and
when the switch is operated in a state in which the door lock is open and at least one of the plurality of portable devices is located in the passenger compartment of the vehicle, the control unit stores the identification code of each portable device located in the passenger compartment.

4. The vehicle communication system according to claim 3, wherein:
when the switch is operated in a state in which the door lock is open, one of the plurality of portable devices is located near the vehicle, and another one of the plurality of portable devices is located in the passenger compartment of the vehicle, the control unit compares the identification code of the portable device located near the vehicle with the identification code of the portable device located in the passenger compartment of the vehicle; and
the control unit closes the door lock when the identification code of the portable device located in the passenger compartment of the vehicle differs from the identification code of the portable device located near the vehicle, and the control unit keeps the door lock open when the identification code of the portable device located in the passenger compartment of the vehicle is the same as the identification code of the portable device located near the vehicle.

5. The vehicle communication system according to claim 1, wherein the control unit generates a misplacement warning if at least one of the plurality of portable devices is located in the passenger compartment of the vehicle when the switch is operated in a state in which the door lock is open.

6. The vehicle communication system according to claim 3, wherein:
when the switch is operated in a state in which the door lock is closed, if one of the plurality of portable devices is located near the vehicle and another one of the portable devices is located in the passenger compartment of the vehicle, the control unit determines whether the identification code of the portable device located near the vehicle is stored; and
the control unit opens the door lock when the identification code of the portable device located near the vehicle is not stored and keeps the door lock closed when the identification code of the portable device located near the vehicle is stored.

7. The vehicle communication system according to claim 6, wherein the control unit deletes the identification code of each portable device that is stored after opening the door lock.

8. The vehicle communication system according to claim 3, wherein when the switch is operated in a state in which the door lock is closed, if one of the plurality of portable devices is located near the vehicle and the identification code of the portable device located near the vehicle differs from the identification code stored in the control unit, the control unit opens the door lock and deletes the identification code of each portable device that is stored.

9. The vehicle communication system according to claim 1, wherein when the switch is operated in a state in which the door lock is closed, the control unit opens the door lock when none of the plurality of portable devices is located in the passenger compartment of the vehicle but at least one of the portable devices is located near the vehicle and keeps the door lock closed when none of the plurality of vehicle devices are located in the passenger compartment of the vehicle nor near the vehicle.
